(19) United States
(12) Patent Application Publication
(10) Pub. No.: US 2012/0028033 A1
(43) Pub. Date: Feb. 2, 2012

(54) PHASE-SEPARATED STRUCTURE AND PRODUCTION METHOD THEREFOR

(75) Inventors: Yoshiharu HATAKEYAMA, Osaka (JP); Saori Fukuzaki, Osaka (JP); Takahiro Fukuoka, Osaka (JP); Tadafumi Ajiri, Miyagi (JP)

(73) Assignees: TOHOKU UNIVERSITY, Sendai-shi (JP); NITTO DENKO CORPORATION, Osaka (JP)

(21) Appl. No.: 13/085,074

(22) Filed: Apr. 12, 2011

(30) Foreign Application Priority Data
Jul. 30, 2010 (JP) 2010-172308

(51) Int. Cl. B32B 5/16; C08L 25/06; C08K 5/057; B82Y 99/00

(52) U.S. Cl. 428/323; 524/398; 977/779

(57) ABSTRACT

The phase-separated structure is composed of a resin phase and a particle phase that is arranged adjacent to the resin phase and that contains organic-inorganic composite particles having an organic group on the surface of inorganic particles. The organic-inorganic composite particles in the particle phase at least have a configuration in which the steric hindrance of the organic group prevents the inorganic particles from contacting each other.

### CROSS-REFERENCE TO RELATED APPLICATIONS

This application claims the benefit of priority of Japanese Patent Application No. 2010-172308, filed on Jul. 30, 2010, the entire contents of which are incorporated herein by reference.

### BACKGROUND OF THE INVENTION

1. Field of the Invention

The present invention relates to a phase-separated structure and a production method therefor.

2. Description of Related Art

In recent years, there has been an expectation that phase-separated structures composed of a resin phase and a particle phase formed from inorganic particles can be applied to various industrial uses.

For example, Japanese Unexamined Patent Publication No. 2008-6817 proposes a phase-separated sheet, in which a dispersion of inorganic fine particles in an organic solvent is applied to the surface of a resin sheet and the solvent is then volatilized to form a fine-particle phase on the sheet surface.

### SUMMARY OF THE INVENTION

In conventional phase-separated structures, however, partial dispersion or dissolution of inorganic particles in the resin results in insufficient phase separation between the resin phase and the particle phase.

An object of the present invention is to provide a phase-separated structure in which a resin phase and a particle phase are separated.

The phase-separated structure of the present invention is composed of a resin phase and a particle phase that is arranged adjacent to the resin phase and that contains organic-inorganic composite particles having an organic group on the surface of inorganic particles, and the organic-inorganic composite particles in the particle phase at least have a configuration in which the steric hindrance of the organic group prevents the inorganic particles from contacting each other.

It is preferable that in the phase-separated structure of the present invention, the particle phase forms a layer.

It is preferable that in the phase-separated structure of the present invention, the particle phase is localized on one side or both sides within the phase-separated structure.

It is preferable that in the phase-separated structure of the present invention, the organic-inorganic composite particles are aligned three-dimensionally to form a layer.

It is preferable that in the phase-separated structure of the present invention, the organic-inorganic composite particles have an average particle diameter of 400 nm or less.

The method for producing a phase-separated structure of the present invention includes the steps of blending a resin and organic-inorganic composite particles having an organic group on the surface of inorganic particles to prepare a particle-containing resin composition; and forming from the particle-containing resin composition a phase-separated structure composed of a resin phase and a particle phase arranged adjacent to the resin phase and formed from the organic-inorganic composite particles.

It is preferable that in the method for producing a phase-separated structure, the organic-inorganic composite particles are produced in a high-temperature solvent.

It is preferable that in the method for producing a phase-separated structure of the present invention, the organic-inorganic composite particles are produced in high-temperature, high-pressure water.

It is preferable that in the method for producing a phase-separated structure of the present invention, the organic-inorganic composite particles are produced so as to at least have a configuration in which the steric hindrance of the organic group prevents the inorganic particles from contacting each other.

In the phase-separated structure of the present invention, the resin layer and the particle phase are phase-separated owing to the affinity between the resin and the organic group of the organic-inorganic composite particles. That is, irrespective of the type of inorganic particle, the resin layer and the particle phase are phase-separated owing to the organic group selected.

Therefore, the phase-separated structure is applicable to various industrial uses.

Moreover, according to the method for producing a phase-separated structure of the present invention, a phase-separated structure composed of a resin phase and a particle phase, in which the resin phase and the particle phase are phase-separated, can be produced using a simple method of forming a phase-separated structure from a particle-containing resin composition.

### BRIEF DESCRIPTION OF THE DRAWINGS

FIG. 1 depicts a phase-separated sheet that is one embodiment of the phase-separated structure of the present invention, with FIG. 1(a) showing an enlarged sectional view and FIG. 1(b) showing an enlarged plan view.

FIG. 2 depicts a diagram showing the steps of producing the phase-separated sheet presented in FIG. 1, with FIG. 2(a) showing the step of applying a particle-containing resin composition to a release sheet to form a coating and FIG. 2(b) showing the step of drying the coating to form a phase-separated sheet.

FIG. 3 depicts an image-processed transmission electron micrograph (TEM) of the organic-inorganic composite particles of Preparation Example 1.

FIG. 4 depicts an image-processed TEM (×250000) of the cross section of the phase-separated sheet of Example 1.

FIG. 5 depicts an image-processed TEM (×250000) of the cross section of the phase-separated sheet of Example 2.

FIG. 6 depicts an image-processed TEM (×250000) of the cross section of the phase-separated sheet of Example 3.

FIG. 7 depicts image-processed TEMs of the cross section of the phase-separated sheet of Example 4, with FIG. 7(a) showing an image-processed TEM at 50000-fold magnification and FIG. 7(b) showing an image-processed TEM at 250000-fold magnification.

FIG. 8 depicts an image-processed TEM (×250000) of the cross section of the phase-separated sheet of Example 5.

FIG. 9 depicts an image-processed TEM (×1000000) of the cross section of the phase-separated sheet of Example 9.

FIG. 10 depicts an image-processed TEM (×1000000) of the cross section of the phase-separated sheet of Example 12.

FIG. 11 depicts an image-processed TEM (×250000) of the cross section of the phase-separated sheet of Example 13.

FIG. 12 depicts an image-processed TEM (×250000) of the cross section of the phase-separated sheet of Example 14.

### DETAILED DESCRIPTION OF THE INVENTION

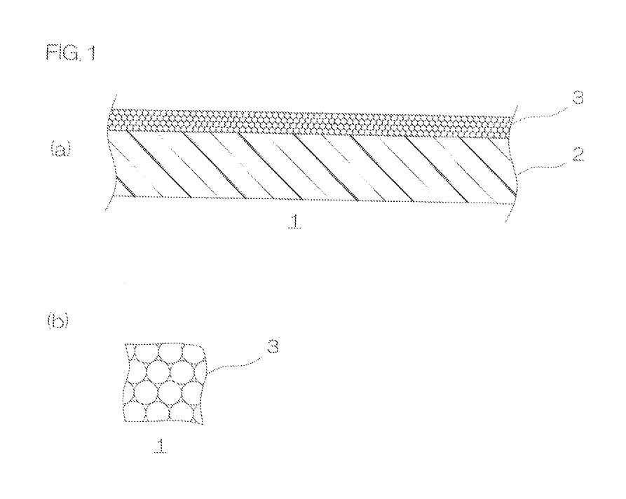

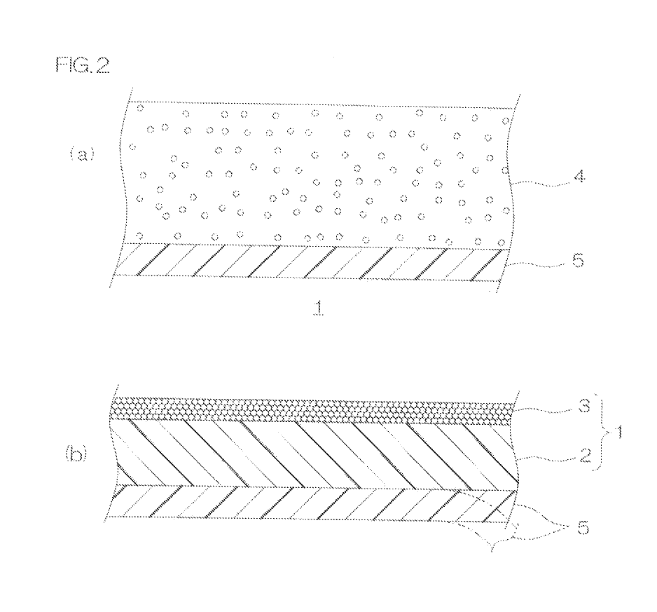

FIG. 1 depicts a phase-separated sheet that is one embodiment of the phase-separated structure of the present invention. FIG. 2 depicts a diagram showing the steps of producing the phase-separated sheet depicted in FIG. 1.

The phase-separated sheet 1 in FIG. 1 (a) is composed of a resin phase 2 and a particle phase 3. Specifically, the phase-separated sheet 1 is formed into a flat plate shape and composed of a resin phase 2 that forms a layer and a particle phase 3 that is provided thereon and that forms another layer.

The resin phase 2 is formed in a sheet form. Due to the fact that the particle phase 3 is localized on one side within the phase-separated sheet 1 as described below, the resin phase 2 forms a layer.

The particle phase 3 is substantially formed from organic-inorganic composite particles only.

The thickness of the resin phase 2 is not particularly limited and the thickness is, for example, 1 nm to 1000 μm, preferably 5 nm to 100 μm, and still more preferably 10 nm to 10 μm.

The particle phase 3 is arranged adjacent to the upper side (one side) of the resin phase 2. In other words, the particle phase 3 is localized on the upper surface of the resin phase 2 within the upper side of the phase-separated sheet 1.

The organic-inorganic composite particles are aligned substantially three-dimensionally, and the particle phase 3 forms a layer while being arranged on the upper surface of the resin phase 2. That is, in the particle phase 3, the organic-inorganic composite particles are aligned in a thickness direction as well as in a planar direction (a direction perpendicular to the thickness direction) of the phase-separated sheet 1.

Specifically, in the particle phase 3, at least there are organic-inorganic composite particles that are arranged three-dimensionally in a substantially regular manner, and in particular, such organic-inorganic composite particles are stacked in a closely packed manner. The organic-inorganic composite particles are stacked so as to have a close-packed structure such as a hexagonal close-packed structure or a cubic close-packed structure.

The thickness of the particle phase 3 is, for example, 1 nm to 1000 μm and preferably 10 nm to 100 μm.

The resin that forms the resin phase 2 is not particularly limited and examples include thermosetting resins and thermoplastic resins.

Examples of thermosetting resins include polycarbonate resin, epoxy resin, thermosetting polyimide resin, phenol resin, urea resin, melamine resin, diallyl phthalate resin, silicone resin, thermosetting urethane resin, and the like.

Examples of thermoplastic resins include olefin resin, acrylic resin, polystyrene resin, polyester resin, polyacrylonitrile resin, maleimide resin, polyvinyl acetate resin, ethylene-vinylacetate copolymer, polyvinyl alcohol resin, polyamide resin, polyvinyl chloride resin, polyacetal resin, polyphenylene oxide resin, polyphenylene sulfide resin, polysulfone resin, polyether sulfone resin, polyether ether ketone resin, polyallylsulfone resin, thermoplastic polyimide resin, thermoplastic urethane resin, polyetherimide resin, polymethylpentene resin, cellulosic resin, liquid crystal polymer, ionomer, and the like.

These resins may be used singly or as a combination of two or more.

Among the aforementioned resins, thermoplastic resins are preferable and high-orientation resins that have high orientation are more preferable. Specific examples include olefin resin, acrylic resin, polystyrene resin, polyester resin, polyvinyl alcohol resin, thermoplastic polyimide resin, polyetherimide resin, and the like.

Examples of olefin resins include cyclic olefin resin and chain olefin resin. Cyclic olefin resin is preferable.

Examples of cyclic olefin resins include polynorbornene, ethylene-norbornene copolymer, and derivatives thereof.

Examples of chain olefin resins include polyethylene, polypropylene, ethylene-propylene copolymer, and the like.

Examples of acrylic resins include polymethylmethacrylate, polyethylmethacrylate, and the like.

Examples of polystyrene resins include polystyrene, poly(α-methylstyrene), styrene-(α-methylstyrene) copolymer, styrene-butadiene copolymer, and the like. Polystyrene is preferable.

Examples of polyester resins include polyarylate, polyethylene terephthalate, polyethylene naphthalate, and the like.

Polyvinyl alcohol resin can be obtained by, for example, the complete or partial saponification of polyvinyl acetate resin obtainable by polymerizing according to a suitable method a vinyl monomer that contains vinyl acetate as a principal component. The degree of saponification of a polyvinyl alcohol resin is, for example, 70 to 100 mol %, preferably 70 to 99.99 mol %, and more preferably 80 to 99.9 mol %.

The organic-inorganic composite particles can be dispersed as primary particles in a solvent (solvents are described below) and/or a resin and are particles that have an organic group on the surface of inorganic particles. Specifically, the organic-inorganic composite particles can be obtained by treating the surface of inorganic particles using an organic compound. One kind of organic-inorganic composite particle may be used or two or more kinds may be used in combination.

Examples of inorganic substances that form inorganic particles include metals including metallic elements such as main group elements and transition elements; nonmetals including nonmetallic elements such as boron and silicon; inorganic compounds containing metallic elements and/or nonmetals; and the like.

Examples of metallic elements and nonmetallic elements include, assuming that a border is created by boron (B) of the IIIB group, silicon (Si) of the IVB group, arsenic (As) of the VB group, tellurium (Te) of the VIB group, and astatine (At) of the VIIB group in the long-form periodic table (IUPAC 1989), these elements and elements that are located on the left side as well as the lower side of the border in the long-form periodic table. Specific examples include the group IIIA elements such as Sc and Y; the group WA elements such as Ti, Zr, and Hf, the group VA elements such as V, Ni), and Ta; the group VIA elements such as Cr, Mo, and W; the group VITA elements such as Mn and Re; the group VIIIA elements such as Fe, Co, Ni, Ru, Rh, Pd, Os, Ir, and Pt; the group TB elements such as Cu, Ag, and Au; the group IIB elements such as Zn, Cd, and Hg; the group MB elements such as B, Al, Ga, In, and Tl; the group IVB elements such as Si, Ge, Sn, and Pb; the group VB elements such as As, Sb, and Bi; the group VIB elements such as Te and Po; the lanthanide series elements such as La, Ce, Pr, and Nd; the actinium series elements such as Ac, Th, and U; and the like.

Examples of inorganic compounds include hydrogen compound, hydroxide, nitride, halide, oxide, carbonate, sulfate, nitrate, metal complex, sulfide, carbide, phosphorus compound, and the like. The inorganic compounds may be composite compounds and examples include oxynitride, composite oxide, and the like.

Among the inorganic substances, inorganic compounds are preferable and particularly preferable examples include oxide, composite oxide, carbonate, sulfate, and the like.

Examples of oxides include metal oxide, with titanium oxides (titanium dioxide, titanium(IV) oxide, and titania: TiO₂) and cerium oxides (cerium dioxide, cerium(IV) oxide, and ceria: CeO₂), being preferable.

Oxides may be used singly or as a combination of two or more.

The composite oxides are compounds of oxygen and a plurality of elements, and the plurality of elements may be a combination of at least two elements selected from the elements other than oxygen present in the aforementioned oxides, the group I elements, and the group II elements.

Examples of the group I elements include alkali metals such as Li, Na, K, Rb, and Cs. Examples of the group II elements include alkaline earth metals such as Be, Mg, Ca, Sr, Ba, and Ra.

Preferable examples of combinations of elements include a combination of a group II element and a group Nb element, a combination of a group II element and a group VIIIb element, a combination of a group II element and a group Na element, and other combinations that contain at least a group II element.

Examples of composite oxides containing at least a group II element include alkaline earth metal titanates, alkaline earth metal zirconates, alkaline earth metal ferrates, alkaline earth metal stannates, and the like.

A preferable composite oxide may be an alkaline earth metal titanate.

Examples of alkaline earth metal titanates include beryllium titanate (BeTiO₃), magnesium titanate (MgTiO₃), calcium titanate (CaTiO₃), strontium titanate (SrTiO₃), barium titanate (BaTiO₃), radium titanate (RaTiO₃), and the like.

Composite oxides may be used singly or as a combination of two or more.

As for carbonates, examples of elements that combine with carbonic acid include alkali metals, alkaline earth metals, and the like. Examples of alkali metals and alkaline earth metals are as described above.

Among the elements that combine with carbonic acid, alkaline earth metals are preferable.

Specifically, preferable carbonates include those containing alkaline earth metals, and examples of such carbonates include beryllium carbonate, magnesium carbonate, calcium carbonate, strontium carbonate, barium carbonate, radium carbonate, and the like. Carbonates may be used singly or as a combination of two or more.

Sulfates are compounds of sulfate ions (SO₄²⁻) and metal cations (more specifically, compounds formed by the substitution of hydrogen atoms of sulfuric acid (H₂SO₄) with a metal), and examples of metals contained in sulfates include alkali metals, alkaline earth metals, and the like. Examples of alkali metals and alkaline earth metals are as described above.

Among the metals, alkaline earth metals are preferable.

Specifically, preferable sulfates include those containing alkaline earth metals, and examples of such sulfates include beryllium sulfate, magnesium sulfate, calcium sulfate, strontium sulfate, barium sulfate, radium sulfate, and the like, with barium sulfate being preferable.

Sulfates may be used singly or as a combination of two or more.

The organic compound is, for example, an organic group-introducing compound that introduces (distributes) an organic group onto the surface of inorganic particles, and specifically the organic compound contains an organic group and a linker that can be bonded to the surface of inorganic particles.

The linker may be suitably selected according to the type of inorganic particle, and examples include functional groups such as a carboxyl group, a phosphate group (—PO(OH)₂, phosphono group), an amino group, a sulfo group, a hydroxyl group, a thiol group, an epoxy group, an isocyanate group (cyano group), a nitro group, an azo group, a silyloxy group, an imino group, an aldehyde group (acyl group), a nitrile group, a vinyl group (polymerizable group), and the like. Preferable examples include a carboxyl group, a phosphate group, an amino group, a sulfo group, a hydroxyl group, a thiol group, an epoxy group, an azo group, a vinyl group, and the like, with a carboxyl group and a phosphate group being particularly preferable.

One or more of these linkers may be contained in the organic compound. In particular, a linker is bonded to a terminal or a side chain of an organic group.

The organic group contains a hydrocarbon group or the like, such as an aliphatic group, an alicyclic group, an araliphatic (it is also defined as aralkyl) group, or an aromatic group.

Examples of aliphatic groups include saturated aliphatic groups, unsaturated aliphatic groups, and the like.

Examples of saturated aliphatic groups include alkyl groups having 1 to 20 carbon atoms.

Examples of alkyl groups include linear or branched alkyl groups (paraffin hydrocarbon groups) having 1 to 20 carbon atoms such as methyl, ethyl, propyl, isopropyl, butyl, isobutyl, sec-butyl, t-butyl, pentyl, isopentyl, neopentyl, hexyl, heptyl, octyl, 2-ethylhexyl, 3,3,5-trimethylhexyl, isooctyl, nonyl, isononyl, decyl, isodecyl, undecyl, dodecyl (lauryl), tridecyl, tetradecyl, pentadecyl, hexadecyl, heptadecyl, octadecyl, nonadecyl, and icosyl. Linear or branched alkyl groups having 4 to 18 carbon atoms are preferable.

Examples of unsaturated aliphatic groups include alkenyl groups and alkynyl groups having 2 to 20 carbon atoms and the like.

Examples of alkenyl groups include alkenyl groups (olefin hydrocarbon groups) having 2 to 20 carbon atoms such as ethenyl, propenyl, butenyl, pentenyl, hexenyl, octenyl, nonenyl, decenyl, undecenyl, dodecenyl, tetradecenyl, hexadecenyl, octadecenyl (oleyl), and icosenyl.

Examples of alkynyl groups include alkynyl groups (acetylene hydrocarbon groups) having 2 to 20 carbon atoms such as ethynyl, propynyl, butyryl, pentynyl, hexynyl, heptynyl, octynyl, decynyl, undecynyl, dodecynyl, tridecynyl, tetradecynyl, pentadecynyl, hexadecynyl, heptadecynyl, and octadecynyl.

Examples of alicyclic groups include cycloalkyl groups having 4 to 20 carbon atoms, cycloalkenylalkylene groups having 7 to 20 carbon atoms, and the like.

Examples of cycloalkyl groups include cyclobutyl, cyclopentyl, cyclohexyl, cycloheptyl, cyclooctyl, cyclononyl, cyclodecyl, cycloundecyl, cyclododecyl, and the like.

Examples of cycloalkenylalkylene groups include norbornene decyl (norboneryl decyl, bicyclo[2.2.1]hept-2-enyl-decyl) and the like.

Examples of araliphatic groups include aralkyl groups having 7 to 20 carbon atoms such as benzyl, phenylethyl, phenylpropyl, phenylbutyl, phenylpentyl, phenylhexyl, phenylheptyl, and diphenylmethyl.

Examples of aromatic groups include aryl groups having 6 to 20 carbon atoms such as phenyl, xylyl, naphthyl, and biphenyl.

The organic groups are hydrophobic groups for imparting hydrophobic properties to the surface of inorganic particles.

Therefore, an organic compound containing an aforementioned hydrophobic group is presented as a hydrophobizing organic compound for performing a hydrophobic treatment on the inorganic particles.

Specific examples of such hydrophobizing organic compounds include aliphatic group-containing carboxylic acids such as saturated aliphatic group-containing carboxylic acids (saturated fatty acids) including hexanoic acid, decanoic acid, dodecanoic acid (lauric acid) and the like; unsaturated aliphatic group-containing carboxylic acids (unsaturated fatty acids) including oleic acid and the like; and the like. Moreover, examples of hydrophobizing organic compounds include alicyclic group-containing carboxylic acids (alicyclic carboxylic acids) such as cyclohexanemonocarboxylic acids; araliphatic group-containing carboxylic acids (araliphatic carboxylic acids) such as 6-phenylhexanoic acid; aromatic group-containing carboxylic acids (aromatic carboxylic acids) such as benzoic acid and toluenecarboxylic acids; and the like. Other examples include saturated aliphatic group-containing phosphonic acids such as decylphosphonic acid; and saturated aliphatic group-containing phosphonic acid esters such as diethyl decylphosphonate, ethyl decylphosphonate, and ethyl octylphosphonate.

Meanwhile, the organic compound can also be presented as a hydrophilizing organic compound for performing a hydrophilizing treatment on the inorganic particles. In this case, the organic group in a hydrophilizing organic compound has a foregoing hydrocarbon group and a hydrophilic group bonded to the hydrocarbon group.

That is, in the hydrophilizing organic compound, the hydrophilic group is bonded to a terminal (the terminal (second terminal) opposite the terminal to which the linker is bonded (first terminal)) or a side chain of the hydrocarbon group.

The hydrophilic group is a functional group that has polarity (i.e., a polar group) and examples include a carboxyl group, a hydroxyl group, a phosphate group, an amino group, a sulfo group, a carbonyl group, a cyano group, a nitro group, an aldehyde group, a thiol group, and the like. One or more of these hydrophilic groups are contained in the hydrophilizing organic compound.

Examples of organic groups containing a carboxyl group (carboxyl group-containing organic groups) include carboxyaliphatic groups such as carboxysaturated aliphatic groups including 3-carboxypropyl, 4-carboxybutyl, 6-carboxyhexyl, 8-carboxyoctyl, and 10-carboxydecyl; and carboxyunsaturated aliphatic groups including carboxybutenyl. Other examples of organic groups containing a carboxyl group include carboxyalicyclic groups such as carboxycyclohexyl; carboxyaraliphatic groups such as carboxyphenylhexyl; carboxyaromatic groups such as carboxyphenyl; and the like.

Examples of organic groups containing a hydroxyl group (hydroxyl group-containing organic groups) include hydroxysaturated aliphatic groups (hydroxyaliphatic groups) including 4-hydroxybutyl, 6-hydroxyhexyl, and 8-hydroxyoctyl; hydroxyaraliphatic groups including 4-hydroxybenzyl, 2-(4-hydroxyphenyl)ethyl, 3-(4-hydroxyphenyl)propyl, and 6-(4-hydroxyphenyl)hexyl; hydroxyaromatic groups including hydroxyphenyl; and the like.

Examples of organic groups containing a phosphate group (phosphate group-containing organic groups) include phosphonosaturated aliphatic groups (phosphonoaliphatic groups) such as 6-phosphonohexyl; phosphonoaraliphatic groups such as 6-phosphonophenylhexyl; and the like.

Examples of organic groups containing an amino group (amino group-containing organic groups) include aminosaturated aliphatic groups (aminoaliphatic groups) such as 6-aminohexyl; aminoaraliphatic groups such as 6-aminophenylhexyl; and the like.

Examples of organic groups containing a sulfo group (sulfo group-containing organic groups) include sulfosaturated aliphatic groups (sulfoaliphatic groups) such as 6-sulfohexyl; sulfoaraliphatic groups such as 6-sulfophenylhexyl; and the like.

Examples of organic groups containing a carbonyl group (carbonyl group-containing organic groups) include oxosaturated aliphatic groups (oxoaliphatic groups) such as 3-oxopentyl; and the like.

Examples of organic groups containing a cyano group (cyano group-containing organic groups) include cyanosaturated aliphatic groups (cyanoaliphatic groups) such as 6-cyanohexyl; and the like.

Examples of organic groups containing a nitro group (nitro group-containing organic groups) include nitrosaturated aliphatic groups (nitroaliphatic groups) such as 6-nitrohexyl; and the like.

Examples of organic groups containing an aldehyde group (aldehyde group-containing organic groups) include aldehydesaturated aliphatic groups (aldehydealiphatic groups) such as 6-aldehydehexyl; and the like.

Examples of organic groups containing a thiol group (thiol group-containing organic groups) include thiolsaturated aliphatic groups (thiolaliphatic groups) such as 6-thiolhexyl; and the like.

Specific examples of hydrophilic group-containing organic compounds include carboxyl group-containing organic compound, hydroxyl group-containing organic compound, phosphate group-containing organic compound, amino group-containing organic compound, sulfo group-containing organic compound, carbonyl group-containing organic compound, cyano group-containing organic compound, nitro group-containing organic compound, aldehyde group-containing organic compound, thiol group-containing organic compound, and the like.

Examples of carboxyl group-containing organic compounds include dicarboxylic acid and the like. Examples of such dicarboxylic acids include saturated aliphatic dicarboxylic acids such as propanedioic acid (malonic acid), butanedioic acid (succinic acid), hexanedioic acid (adipic acid), octanedioic acid, decanedionic acid (sebacic acid); unsaturated aliphatic dicarboxylic acids such as itaconic acid; alicyclic dicarboxylic acids such as cyclohexyl dicarboxylic acid; araliphatic dicarboxylic acids such as 6-carboxyphenyl hexanoic acid; aromatic dicarboxylic acids such as phthalic acid, terephthalic acid, and isophthalic acid; and the like. Carboxyl group-containing phosphoric esters are also included in carboxyl group-containing organic compounds, and specific examples include decyl carboxylate ethyl phosphate, octyl carboxyate ethyl phosphate, and the like.

Examples of hydroxyl group-containing organic compounds include monohydroxycarboxylic acids, and specific examples of such monohydroxycarboxylic acids include 4-hydroxybutanoic acid, 6-hydroxyhexanoic acid, 8-hydroxyoctanoic acid, 4-hydroxyphenylacetic acid, 3-(4-hydroxyphenyl)propionic acid, 6-(4-hydroxyphenyl)hexanoic acid, hydroxybenzoic acid, and the like.

Examples of phosphate group-containing organic compounds include monophosphonocarboxylic acids, and specific examples include 6-phosphonohexanoic acid, 6-phosphonophenylhexanoic acid, and the like.

Examples of amino group-containing organic compounds include monoaminocarboxylic acids, and specific examples include 6-aminohexanoic acid, 6-aminophenylhexanoic acid, and the like.

Examples of sulfo group-containing organic compounds include monosulfocarboxylic acids, and specific examples include 6-sulfohexanoic acid, 6-sulfophenylhexanoic acid, and the like.

Examples of carbonyl group-containing organic compounds include monocarbonylcarboxylic acids, and specific examples include 4-oxovaleric acid and the like.

Examples of cyano group-containing organic compounds include monocyanocarboxylic acids, and specific examples include 6-cyanohexanoic acid and the like.

Examples of nitro group-containing organic compounds include mononitrocarboxylic acids, and specific examples include 6-nitrohexanoic acid and the like.

Examples of aldehyde group-containing organic compounds include monoaldehydecarboxylic acids, and specific examples include 6-aldehydehexanoic acid and the like.

Examples of thiol group-containing organic compounds include monothiolcarboxylic acids, and specific examples include 6-thiolhexanoic acid and the like.

The organic group may contain the same or different organic group components.

When the organic group components are different, i.e., when the organic group contains different kinds of organic group components, the organic groups contain homologous organic groups and/or heterologous organic groups.

Examples of homologous organic groups include a combination of plural aliphatic groups, a combination of a plurality of alicyclic groups, a combination of plural araliphatic groups, and a combination of plural aromatic groups. Also, examples of homologous organic groups include a combination of plural carboxyaliphatic groups, a combination of plural carboxyalicyclic groups, a combination of plural carboxyaraliphatic groups, a combination of plural carboxyaromatic groups, a combination of plural hydroxyaliphatic groups, a combination of plural hydroxyaraliphatic groups, a combination of plural hydroxyaromatic groups, a combination of plural phosphonoaliphatic groups, a combination of plural phosphonoaraliphatic groups, a combination of plural aminoaliphatic groups, a combination of plural aminoaraliphatic groups, a combination of plural sulfoaliphatic groups, a combination of plural sulfoaraliphatic groups, a combination of plural oxoaliphatic groups, a combination of plural cyanoaliphatic groups, a combination of plural nitroaliphatic groups, a combination of plural aldehydealiphatic groups, a combination of plural thiolaliphatic groups, and the like.

As for the homologous organic groups, a combination of plural aliphatic groups is preferable, a combination of plural saturated aliphatic groups is more preferable, and a combination of a saturated aliphatic group having less than 10 carbon atoms and a saturated aliphatic group having 10 or more carbon atoms is particularly preferable. A specific example may be a combination of hexyl and decyl.

When the organic group contains homologous organic groups, the organic group contains organic groups having different sizes (length and/or scale, i.e., the number of carbon atoms). Therefore, a molecule of a resin enters into the space (pocket) corresponding to a small organic group sandwiched between the adjacent large organic groups, and it is thus possible to enhance the interaction of the large organic groups and the molecule of the resin. As a result, the dispersibility of the organic-inorganic composite particles can be enhanced.

Examples of heterologous organic groups include combinations of at least two heterologous groups selected from the group consisting of aliphatic groups, alicyclic groups, araliphatic groups, aromatic groups, carboxyaliphatic groups, carboxyalicyclic groups, carboxyaraliphatic groups, carboxyaromatic groups, hydroxyaliphatic groups, hydroxyaraliphatic groups, hydroxyaromatic groups, phosphonoaliphatic groups, phosphonoaraliphatic groups, aminoaliphatic groups, aminoaraliphatic groups, sulfoaliphatic groups, sulfoaraliphatic groups, oxoaliphatic groups, cyanoaliphatic groups, nitroaliphatic groups, aldehydealiphatic groups, and thiolaliphatic groups.

As for the heterologous organic groups, a combination of an araliphatic group and an aromatic group is preferable and a combination of an araliphatic group having 7 to 15 carbon atoms and an aromatic group having 6 to 12 carbon atoms is more preferable. A specific example may be a combination of phenylhexyl and phenyl.

Also, as for the heterologous organic groups, a combination of an aliphatic group and a hydroxyaliphatic group is preferable, a combination of a saturated aliphatic group and a hydroxysaturated aliphatic group is more preferable, and a combination of a saturated aliphatic group having 10 or more carbon atoms and a hydroxysaturated aliphatic group having less than 10 carbon atoms is particularly preferable. A specific example may be a combination of decyl and 6-hydroxyhexyl.

In the case where the resin is prepared as a mixture of different resin components, the organic group can exhibit excellent compatibility with the resin if the organic group contains heterologous organic groups because the respective organic groups exhibit excellent compatibility with the respective molecules of the resin of the resin components. Therefore, the interaction between the organic group and the molecules of the resin of the resin components can be enhanced. As a result, the dispersibility of the organic-inorganic composite particles can be enhanced.

The organic group is present on the surface of the inorganic particles in the organic-inorganic composite particles. Specifically, the organic group stretches outward from the surface of the inorganic particles via a linker.

The organic-inorganic composite particles are produced by subjecting an inorganic substance and an organic compound to a reaction treatment, preferably a high-temperature treatment.

The high-temperature treatment is carried out in a solvent. Examples of solvents include water and organic compounds as mentioned above.

Specifically, an inorganic substance and an organic compound are subjected to a high-temperature treatment in water under high pressures (hydrothermal synthesis: hydrothermal reaction) or an inorganic substance is subjected to a high-temperature treatment in an organic compound (a high-temperature treatment in an organic compound) to give organic-inorganic composite particles. That is, the surface of inorganic particles formed of an inorganic substance is treated with an organic compound to give organic-inorganic composite particles.

For example, in hydrothermal synthesis, the inorganic substance and the organic compound are reacted under high-temperature, high-pressure conditions in the presence of water (first hydrothermal synthesis).

The inorganic substance subjected to the first hydrothermal synthesis is preferably a carbonate, a sulfate, or an oxide. An oxide is particularly preferable.

That is, first, an inorganic substance, an organic compound, and water are charged into a pressure-resistant, airtight container, and the ingredients are heated so as to prepare a reaction system under high-temperature, high-pressure conditions.

As for the proportions of respective ingredients, the proportion of the organic compound is, for example, 1 to 1500 parts by mass, preferably 5 to 500 parts by mass, more preferably 5 to 250 parts by mass, and the proportion of water is, for example, 50 to 8000 parts by mass, preferably 80 to 6600 parts by mass, and more preferably 100 to 4500 parts by mass, per 100 parts by mass of inorganic substance.

Since the density of the organic compound is normally 0.8 to 1.1 g/mL, the proportion of the organic compound is, for example, 1 to 1500 mL, preferably 5 to 500 mL, and more preferably 5 to 250 mL, per 100 g of inorganic substance.

The molar proportion of the organic compound is, for example, 0.01 to 1000 mol, preferably 0.02 to 50 mol, and more preferably 0.1 to 10 mol, per one mol of inorganic substance.

Specifically, when the organic compound contains a plurality of (e.g., two) different organic groups, the organic compound is used such that the molar ratio of one organic group to the other organic group is, for example, 10:90 to 99.9:0.1 and preferably 20:80 to 99:1.

Since the density of water is normally about 1 g/mL, the proportion of water is, for example, 50 to 8000 mL, preferably 80 to 6600 mL, and more preferably 100 to 4500 mL, per 100 g of inorganic substance.

Specifically, as for the reaction conditions in a hydrothermal reaction, the heating temperature is, for example, 100 to 500° C. and preferably 200 to 400° C. The pressure is, for example, 0.2 to 50 MPa, preferably 1 to 50 MPa, and more preferably 10 to 50 MPa. The reaction time is, for example, 1 to 200 minutes and preferably 3 to 150 minutes. Meanwhile, when a continuous reactor is used, the reaction time may be 1 minute or less.

The reaction products obtained after the reaction mainly include a precipitate mostly precipitating in water and a deposit adhering to the inner wall of the airtight container.

The precipitate may be acquired by, for example, sedimentation separation in which the reaction products are subjected to gravity or a centrifugal field to settle the precipitate. Preferably, the precipitate is obtained as a precipitate of the reaction products by centrifugal sedimentation (centrifugal separation) in which settling takes place in a centrifugal field.

The deposit is collected with, for example, a spatula or the like.

In this manner, organic-inorganic composite particles having an organic group on the surface of inorganic particles are obtained.

In the first hydrothermal synthesis, the pre-reaction inorganic substance and the post-reaction inorganic substance that forms inorganic particles are the same.

Alternatively, by subjecting an inorganic substance (starting material) and an organic compound to a hydrothermal synthesis, it is also possible to obtain organic-inorganic composite particles containing inorganic particles formed of an inorganic substance that is different from the starting inorganic substance (second hydrothermal synthesis).

Examples of the inorganic substance subjected to the second hydrothermal synthesis include hydroxides, metal complexes, nitrates, sulfates, and the like. Hydroxides and metal complexes are preferable.

Examples of the elements contained in the hydroxides (elements that serves as cations combining with the hydroxyl ion (OH⁻)) include the same elements that combine with oxygen in the above-described oxides.

Specific examples of hydroxides include titanium hydroxide (Ti(OH)₄) and cerium hydroxide (Ce(OH)₄).

The metallic elements contained in the metal complexes are those that form composite oxides with the metals contained in the above-described hydroxides, and examples include titanium, iron, tin, zirconium, and the like. Titanium is preferable.

Examples of ligands in the metal complexes include monohydroxycarboxylic acids such as 2-hydroxyoctanoic acid; and the like.

Examples of metal complexes include 2-hydroxyoctanoic acid titanate and the like. Metal complexes can be obtained from the aforementioned metallic elements and ligands according to known methods.

Examples of organic compounds include organic compounds as used for the first hydrothermal synthesis.

In the second hydrothermal synthesis, an inorganic substance and an organic compound are reacted under high-temperature, high-pressure conditions in the presence of water.

As for the proportions of respective ingredients, the proportion of the organic compound is, for example, 1 to 1500 parts by mass, preferably 5 to 500 parts by mass, and more preferably 5 to 250 parts by mass, and the proportion of water is for example, 50 to 8000 parts by mass, preferably 80 to 6600 parts by mass, and more preferably 80 to 4500 parts by mass, per 100 parts by mass of inorganic compound.

The proportion of the organic compound is, for example, 0.9 to 1880 mL, preferably 4.5 to 630 mL, and more preferably 4.5 to 320 mL, per 100 g of hydroxide. The molar proportion of the organic compound is, for example, 0.01 to 10000 mol and preferably 0.1 to 10 mol per one mol of hydroxide.

The proportion of water is, for example, 50 to 8000 mL, preferably 80 to 6600 mL, and more preferably 100 to 4500 mL, per 100 g of hydroxide.

The reaction conditions in the second hydrothermal synthesis are the same as the reaction conditions in the first hydrothermal synthesis described above.

In this manner, organic-inorganic composite particles having an organic group on the surface of inorganic particles formed of an inorganic substance that is different from the starting inorganic substance are obtained.

The formulation used for the second hydrothermal synthesis may further include, in addition to the aforementioned ingredients, a carbonic acid source or a hydrogen source.

Examples of carbonic acid sources include carbon dioxide (carbon dioxide gas), and formic acid and/or urea.

Examples of hydrogen sources include hydrogen (hydrogen gas); acids such as formic acid and lactic acid; hydrocarbons such as methane and ethane; and the like.

The proportion of the carbonic acid source or the hydrogen source is, for example, 5 to 140 parts by mass and preferably 10 to 70 parts by mass per 100 parts by mass of inorganic substance.

Alternatively, the proportion of the carbonic acid source may be, for example, 5 to 100 mL and preferably 10 to 50 mL per 100 g of inorganic substance. The molar proportion of the carbonic acid source may be, for example, 0.4 to 100 mol, preferably 1.01 to 10.0 mol, and more preferably 1.05 to 1.30 mol, per one mol of inorganic substance.

Alternatively, the proportion of the hydrogen source may be, for example, 5 to 100 mL and preferably 10 to 50 mL per 100 g of inorganic substance. The molar proportion of the hydrogen source may be, for example, 0.4 to 100 mol, preferably 1.01 to 10.0 mol, and more preferably 1.05 to 2.0 mol, per one mol of inorganic substance.

In the high-temperature treatment performed in the organic compound, the inorganic substance and the organic compound are blended and heated, for example, under ordinary pressures. While being subjected to the high-temperature treatment, the organic compound serves as an organic group-introducing compound as well as a solvent for dispersing or dissolving the inorganic substance.

The proportion of the organic compound is, for example, 10 to 10000 parts by mass and preferably 100 to 1000 parts by mass per 100 parts by mass of inorganic substance. In terms of volume, the proportion of the organic compound is, for example, 10 to 10000 mL and preferably 100 to 1000 mL per 100 g of inorganic substance.

The heating temperature is, for example, greater than 100° C., preferably 125° C. or greater, and more preferably 150° C. or greater, and usually 300° C. or less and preferably 275° C. or less. The heating time is, for example, 1 to 60 minutes and preferably 3 to 30 minutes.

The shape of the organic-inorganic composite particles (primary particles) obtained in this manner is not particularly limited and may be, for example, anisotropic or isotropic, and the average particle diameter thereof (maximum length when anisotropic) is, for example, 200 μm or less, preferably 1 nm to 200 μm, more preferably 3 nm to 50 μm, and particularly preferably 3 nm to 10 μm.

As described in detail in the examples below, the average particle diameter of the organic-inorganic composite particles may be determined by dynamic light scattering (DLS) and/or calculated from a transmission electron microscopic (TEM) or scanning electron microscopic (SEM) image analysis.

When the average particle diameter is lower than the aforementioned range, the proportion of the volume of the organic group relative to the surface of the organic-inorganic composite particles is high, and the function of the inorganic particles is unlikely to be ensured.

When the average particle diameter exceeds the aforementioned range, particles may be crushed when being blended with the resin.

The organic-inorganic composite particles obtained in this manner are unlikely to agglomerate in a dry state, and even when the particles appear to be agglomerated in a dry state, agglomeration (formation of secondary particles) is inhibited in a particle-dispersed resin composition as well as in a particle-dispersed resin article, and the particles are dispersed nearly uniformly as primary particles in the resin.

That is, the organic-inorganic composite particles at least have a configuration in which the steric hindrance of the organic group prevents the inorganic particles from contacting each other.

The organic-inorganic composite particles obtained by the first or second hydrothermal syntheses or the high-temperature treatment performed in an organic compound may then be subjected to washing and/or wet classification if necessary.

To wash the organic-inorganic composite particles, for example, a solvent is added to the organic-inorganic composite particles obtained by the first or second hydrothermal syntheses or the high-temperature treatment performed in an organic compound to wash away the unreacted organic compound (that is, the organic compound is dissolved in a solvent) and then the solvent is removed and the particles are recovered (separated).

Examples of solvents include alcohols (hydroxyl group-containing aliphatic hydrocarbons) such as methanol, ethanol, propanol, and isopropanol; ketones (carbonyl group-containing aliphatic hydrocarbons) such as acetone, methyl ethyl ketone, cyclohexanone, cyclopentanone; aliphatic hydrocarbons (in particular, alkanes and the like) such as pentane, hexane, and heptane; halogenated aliphatic hydrocarbons such as dichloromethane, chloroform, and trichloroethane; halogenated aromatic hydrocarbons such as chlorobenzene and dichlorobenzene; ethers such as tetrahydrofuran; aromatic hydrocarbons such as benzene, toluene, and xylene; water; aqueous pH controlling solutions such as aqueous ammonia; and the like. Alcohols and water are preferable.

The organic-inorganic composite particles after washing are separated from the solvent (supernatant) by, for example, filtration, decantation, or a similar technique, and then recovered. Thereafter, the recovered substance may be dried by, for example, heating or in an air stream if necessary.

To perform wet classification on the organic-inorganic composite particles, for example, a solvent is added to the organic-inorganic composite particles obtained by the first or second hydrothermal syntheses or the high-temperature treatment performed in an organic compound or a solvent is added to the organic-inorganic composite particles after washing, and the mixture is stirred and then left to stand still or subjected to centrifugal sedimentation so as to separate the mixture into supernatant and precipitate. The solvent may be the same as those described above, and specific examples include halogenated aliphatic hydrocarbons, aromatic hydrocarbons, aliphatic hydrocarbons, hydroxyl group-containing aliphatic hydrocarbons, carbonyl group-containing aliphatic hydrocarbons, aqueous pH controlling solutions, and the like.

The supernatant is then recovered.

In wet classification, the recovered supernatant may further be filtered. A filter having a pore size of, for example, 500 nm or less and preferably 400 nm or less, and usually 1 nm or greater is used for filtration.

The solvent is then removed from the recovered substance, thereby giving organic-inorganic composite particles.

Wet classification allows organic-inorganic composite particles of a small size to be obtained.

The shape of the organic-inorganic composite particles (primary particles) obtained in this manner is not particularly limited and may be, for example, substantially rectangular parallelepiped such as substantially cubic; substantially spherical; spheroidal such as substantially prolate spheroidal (or spindle-shaped) and oblate spheroidal; acicular; or cylindrical. Preferably, the particles are substantially cubic or substantially spherical. As long as the organic-inorganic composite particles are substantially cubic or spherical, the organic-inorganic composite particles can be securely and readily close-packed in the particle phase 3.

The average particle diameter of the organic-inorganic composite particles is, for example, 400 nm or less, preferably 300 nm or less, more preferably 200 nm or less, and particularly preferably 100 nm or less, and usually 1 nm or greater and preferably 2 nm or greater. The average particle diameter of the organic-inorganic composite particles may be determined according to a known method. In particular, the average particle diameter is determined, as described in detail in the examples below, by dynamic light scattering (DLS) and/or calculated from a transmission electron microscopic (TEM) or scanning electron microscopic (SEM) image analysis.

When the average particle diameter of the organic-inorganic composite particles exceeds the aforementioned range, individual particles (each particle) are heavy, sometimes making it difficult to form the phase separation sheet 1

The organic-inorganic composite particles obtained in this manner are unlikely to agglomerate in a dry state, and even when the particles appear to be agglomerated in a dry state, agglomeration (formation of secondary particles) is inhibited in a particle dispersion as well as in a particle-containing resin composition solution (varnish, described below), and the particles are dispersed nearly uniformly as primary particles in a solvent.

Furthermore, even if dried once, the organic-inorganic composite particles of the present invention can be re-dispersed easily as primary particles when a solvent is added to the organic-inorganic composite particles.

The organic-inorganic composite particles at least have a configuration in which the steric hindrance of the organic group prevents the inorganic particles from contacting each other.

In the organic-inorganic composite particles, the proportion of the surface area of the organic group relative to the surface area of the inorganic particles, i.e., the surface coverage by the organic group in the organic-inorganic composite particles (=(surface area of organic group/surface area of inorganic particle)×100) is usually, for example, 30% or greater and preferably 60% or greater, and usually 200% or less.

In the calculation of surface coverage, first, the shape of the inorganic particles is determined by transmission electron microscopy (TEM), the average particle diameter is then calculated, and the specific surface area of the particles is calculated from the shape of the inorganic particles and the average particle diameter. Alternatively, the proportion of the organic group accounting for the organic-inorganic composite particles is calculated from the weight change resulting from heating the organic-inorganic composite particles to 800° C. using a differential thermal balance (TG-DTA); the amount of the organic group per particle is then calculated from the molecular weight of the organic group, the particle density, and the average volume; and the surface coverage is determined from these factors.

When at least the surface coverage is high and the organic group of the organic-inorganic composite particles has a length sufficient to cancel the electric charge of the inorganic particles, the kind of solvent (medium) for dispersing the organic-inorganic composite particles may be selected (specified or managed) according to the kind of organic group.

The resin and the organic-inorganic composite particles may also be selected such that their solubility parameters (SP values) satisfy a specific relationship.

Hereafter, a method for producing the phase-separated sheet 1 is now described with reference to FIG. 2.

In the method, first, a resin and organic-inorganic composite particles are blended so as to prepare a particle-containing resin composition.

Specifically, the particle-containing resin composition is prepared by blending, for example, a solvent, organic-inorganic composite particles, and a resin, and stirring the ingredients (solution preparation). The particle-containing resin composition prepared in this manner is regarded as a solvent-containing varnish.

In the particle-containing resin composition, organic-inorganic composite particles are dispersed as primary particles in a solvent and a resin.

The solvent is not particularly limited and examples include those usable in the above-described washing. In addition to those solvents, other examples include alicyclic hydrocarbons (in particular, cycloalkyls) such as cyclopentane and cyclohexane; esters such as ethyl acetate; polyols such as ethylene glycol and glycerol; nitrogen-containing compounds such as N-methylpyrrolidone, pyridine, acetonitrile, and dimethylformamide; acryl-based monomers such as isostearyl acrylate, lauryl acrylate, isoboronyl acrylate, butyl acrylate, methacrylate, acrylic acid, tetrahydrofurfuryl acrylate, 1,6-hexanediol diacrylate, 2-hydroxyethyl acrylate, 4-hydroxybutyl acrylate, phenoxyethyl acrylate, and acryloylmorpholine; vinyl group-containing monomers such as styrene and ethylene; epoxy-group containing monomers such as bisphenol A epoxy; and the like.

These solvents may be used singly or as a combination of two or more. Halogenated aliphatic hydrocarbons and aromatic hydrocarbons are preferable.

Specifically, to prepare a particle-containing resin composition, first, a solvent and a resin are blended so as to dissolve the resin in the solvent to give a resin solution. The resin solution and organic-inorganic composite particles are then blended and stirred so as to prepare a particle-containing resin composition (first preparation method).

The proportion of the resin is, for example, 40 parts by mass or less, preferably 35 parts by mass or less, and more preferably 30 parts by mass or less, and usually 0.1 parts by mass or greater, preferably 0.5 parts by mass or greater, and more preferably 1 part by mass or greater, per 100 parts by mass of resin solution. When the proportion of the resin exceeds the aforementioned range, the solubility of the resin may be impaired.

The proportion of the organic-inorganic composite particles is, for example, 1 to 1000 parts by mass, preferably 5 to 800 parts by mass, and more preferably 10 to 600 parts by mass, per 100 parts by mass of the solids content (resin) of the resin solution.

Alternatively, a particle-containing resin composition can also be prepared by, for example, blending a solvent and organic-inorganic composite particles so as to disperse the organic-inorganic composite particles in the solvent, thereby preparing a particle dispersion, and then blending and stirring the particle dispersion and a resin (second preparation method).

In the particle dispersion, the organic-inorganic composite particles are dispersed as primary particles in the solvent.

The proportion of the organic-inorganic composite particles is, for example, 0.1 to 70 parts by mass, preferably 0.2 to 60 parts by mass, and more preferably 0.5 to 50 parts by mass, per 100 parts by mass of particle dispersion.

The proportion of the resin is, for example, 1 to 10000 parts by mass, preferably 10 to 2000 parts by mass, and more preferably 20 to 1000 parts by mass, per 100 parts by mass of the solids content (organic-inorganic composite particles) of the particle dispersion.

Alternatively, a particle-containing resin composition can also be prepared by, for example, first, individually preparing a resin solution and a particle dispersion and then blending and stirring the resin solution and the particle dispersion (third preparation method).

The proportion of resin blended in the resin solution is the same as that described for the first preparation method.

The proportion of organic-inorganic composite particle blended in the particle dispersion is the same as that described for the second preparing method.

The resin solution and the particle dispersion are blended such that the weight ratio of the resin and the organic-inorganic composite particles (the mass of resin: the mass of organic-inorganic composite particle) is, for example, 99:1 to 10:90, preferably 95:5 to 20:80, and more preferably 90:10 to 30:70.

Furthermore, a particle-containing resin composition can also be prepared by, for example, first, blending a solvent, organic-inorganic composite particles, and a resin at once and stirring these ingredients (fourth preparation method).

As for the proportions of respective ingredients, the proportion of the organic-inorganic composite particles is, for example, 0.1 to 50 parts by mass, preferably 1 to 40 parts by mass, and more preferably 3 to 30 parts by mass, and the proportion of resin is 40 parts by mass or less, preferably 35 parts by mass or less, and usually 0.1 parts by mass or greater, per 100 parts by mass of the total weight of the particle-containing resin composition. The proportion of the solvent corresponds to the remainder of removing the organic-inorganic composite particles and the resin from the particle-containing resin composition.

Furthermore, a particle-containing resin composition can also be prepared by, for example, heating a resin without blending a solvent so as to melt the resin and blending the resin with organic-inorganic composite particles (fifth preparation method).

The particle-containing resin composition prepared in this manner is a molten material of the particle-containing resin composition that does not contain a solvent.

When the resin is composed of a thermoplastic resin, the heating temperature is the same as the melting temperature of the resin or greater and in particular the heating temperature is 200 to 350° C. When the resin is composed of a thermosetting resin, the heating temperature is a temperature at which the state of the resin is at the B stage, for example, 85 to 140° C.

The resin and the organic-inorganic composite particles are blended such that the weight ratio of the resin and the organic-inorganic composite particles (the mass of resin: the mass of organic-inorganic composite particle) is, for example, 99:1 to 10:90, preferably 95:5 to 15:85, and more preferably 90:10 to 20:80.

Among the first to fifth preparation methods described above, the first to fourth preparation methods are preferable and the third and fourth preparation methods are particularly preferable.

In the particle-containing resin composition obtained according to the preparation methods described above, organic-inorganic composite particles are uniformly dispersed in a resin. In detail, in the particle-containing resin composition, organic-inorganic composite particles are dispersed as primary particles (substantially without being agglomerated) in a resin.

The resulting particle-containing resin composition is then applied to, for example, a release sheet 5 to prepare a coating 4, and this coating is dried to be formed into a phase-separated sheet 1.

The release sheet 5 is formed into a sheet and composed of, for example, resin materials such as polyethylene, polypropylene, polyethylene terephthalate; and metallic materials such as copper, iron, stainless steel. Resin materials are preferable.

The particle-containing resin composition is applied using, for example, an application method such as a spin coater method, a bar coater method, or a brush application method. Simultaneously with or immediately after the application of the particle-containing resin composition, the solvent is removed by volatilization. If necessary, the solvent may be dried by being heated after the application of the resin composition.

Due to the drying of the coating 4 (in particular, the volatilization of the solvent), the organic-inorganic composite particles are three-dimensionally aligned on the upper side within the phase-separated sheet 1, thus forming a layer of the particle phase 3 on the upper side. Accordingly, the particle phase 3 is localized on the upper side within the phase-separated sheet 1, and the resin phase 2 is thus formed as a layer on the lower side. That is, the phase-separated sheet 1 is composed of the resin phase 2 formed as a layer on the lower side and the particle phase 3 formed as a layer over the resin phase 2.

In the phase-separated sheet 1 thus obtained, a resin layer and a particle phase are phase-separated owing to the affinity between the resin and the organic group of the organic-inorganic composite particles. That is, irrespective of the type of inorganic particle, the resin phase 2 and the particle phase 3 are phase-separated due to the organic group selected.

Thus, the phase-separated sheet 1 is applicable to various industrial uses.

When the phase-separated sheet 1 is actually used, the release sheet 5 is removed from the phase-separated sheet 1 (from the resin phase 2) as indicated by the phantom line in FIG. 2(b).

Moreover, according to the method described above, a phase-separated sheet 1 composed of a resin phase 2 and a particle phase 3, in which the resin phase 2 and the particle phase 3 are separated, can be produced using a simple method from a particle-containing resin composition, i.e., a simple method of applying a particle-containing resin composition.

In the above-described method, the phase-separated structure of the present invention is formed as the phase-separated sheet 1 by applying a particle-containing resin composition, but the phase-separated structure of the present invention can also be formed as a phase-separated block (bulk) by, for example, pouring (casting, potting) the resin composition into a metal mold or the like and, if necessary, performing thermoforming thereon with a heat press or the like.

In the particle phase 3 described above, the organic-inorganic composite particles are aligned three-dimensionally. Although not shown, the organic-inorganic composite particles may be aligned, for example, two-dimensionally, in particular, in a planar direction of the phase-separated sheet 1. In this case, the organic-inorganic composite particles do not stack in a thickness direction in the particle phase 3 and thus the particle phase 3 is monolayered, making the thickness of the particle phase 3 substantially the same as the average particle diameter of the organic-inorganic composite particles.

Preferably, the organic-inorganic composite particles are aligned three-dimensionally.

The particle phase 3 may be localized on the lower side within the phase-separated sheet 1, i.e., on the lower surface of the resin phase 2.

In this case, although not shown, the resin phase 2 is formed on the upper side and the particle phase 3 is formed on the lower side within the phase-separated sheet 1. That is, the particle phase 3 is laminated on the upper surface of the release sheet 5 and the resin phase 2 is exposed to air.

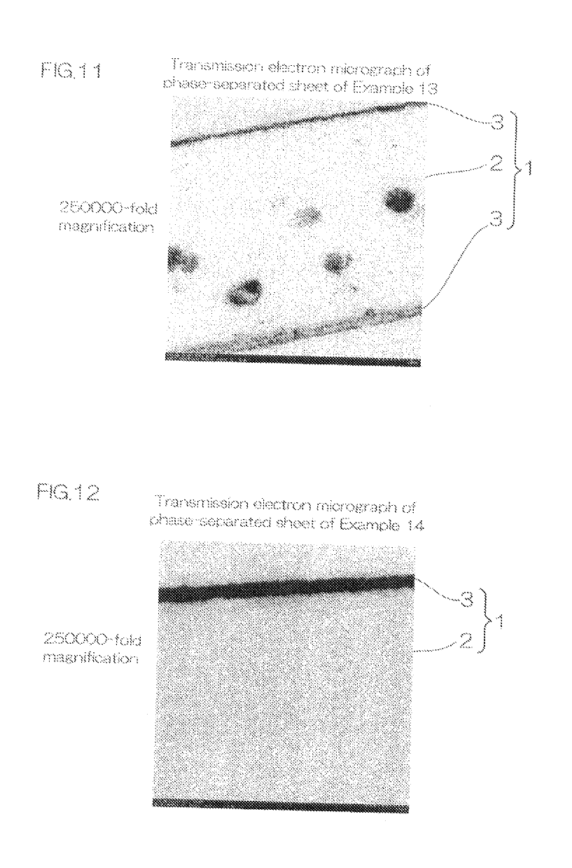

Moreover, as shown in FIG. 11, the particle phase 3 may be localized on both the upper side and the lower side within the phase-separated sheet 1, i.e., on both the upper surface and the lower surface of the resin layer 2.

Within the phase separation sheet 1 in this case, the particle phase 3 is formed on the upper side and the lower side and the resin phase 2 is formed therebetween. That is, particle phases 3 are arranged so as to sandwich the resin layer 2.

### EXAMPLES

The present invention shall be described in more detail below by way of preparation examples, comparative preparation examples, examples, and comparative examples. However, the present invention is not limited to these examples.

The organic-inorganic composite particles and the phase-separated sheets were evaluated according to the following methods.

### (1) X-Ray Diffractometry (XRD)

Glass holders were filled with organic-inorganic composite particles and X-ray diffractometry was performed thereon under the following conditions. Thereafter, in reference to the obtained peaks, the components of the inorganic particles were assigned through database search.

X-ray diffractometer: D8 DISCOVER with GADDS, manufactured by Bruker AXS Optical system on incident side

X-ray source: CuKα (λ=1.542 Å), 45 kV, 360 mA

Spectroscope (monochromator): multilayer mirror

Collimator diameter: 300 μm

Optical system on light-receiving side

Counter: two-dimensional PSPC (Hi-STAR)

Distance between organic-inorganic composite particles and counter: 15 cm 2θ=20, 50 or 80 degrees, ω=10, 25, 40 degrees, Phi=0 degrees, Psi=0 degrees

Measurement time: 10 minutes

Assignment (semiquantitation software): FPM EVA, manufactured by BrukerAXS

### (2) Fourier Transform Infrared Spectrophotometry (FT-IR)

Fourier transform infrared spectrophotometry was performed on the organic-inorganic composite particles according to the KBr method using the following equipment.

Fourier transform infrared spectrophotometer: FT/IRplus, manufactured by JASCO Corporation.

### (3) Measurement of Average Particle Diameter by Dynamic Light Scattering (DLS)

The organic-inorganic composite particles were dispersed in a solvent (a good solvent in which the organic-inorganic composite particles disperse as primary particles, such as cyclohexane, chloroform, hexane, toluene, ethanol, or aqueous ammonia) to prepare a sample (a solids concentration of 1 mass % or less), and the average particle diameter of the organic-inorganic composite particles in the sample was measured with a dynamic light scattering photometer (model number: “ZEN3600”, manufactured by Sysmex Corporation).

(4) Observation with Transmission Electron Microscope (TEM)

The phase-separated sheets of the examples were cut in a thickness direction, and the cut surface was visually inspected with a transmission electron microscope (TEM, H-7650, manufactured by Hitachi High-Technologies Corp.) to examine the state of separation of the resin phase and the particle phase and the shape of the organic-inorganic composite particles and to measure the thickness of the resin phase and the particle phase.

The state of phase separation was evaluated according to the following criteria:

good: A particle phase (segregated phase) was formed on at least the entire surface sides.
fair: A particle phase (segregated phase) was partially formed on at least one of the surface sides.
poor: No particle phase (segregated phase) was formed.

In the TEM observation, a film was embedded in an epoxy resin and cut so as to form a clear cut surface of the film.

Separately, a particle dispersion (a solids concentration of 1 mass % or less) of organic-inorganic composite particles diluted with a solvent was added to a TEM grid (collodion film, carbon supporting film) and dried, and organic-inorganic composite particles were visually inspected with a transmission electron microscope (TEM). An image analysis was performed to calculate the average particle diameter of the organic-inorganic composite particles.

### PREPARATION OF ORGANIC-INORGANIC COMPOSITE PARTICLES

### Preparation Example 1

1.09 g of cerium hydroxide (Ce(OH)₄, manufactured by Wako Pure Chemical Industries, Ltd.), 1.0362 mL of decanoic acid, and 1.010 mL of pure water were charged into a 5 mL high-pressure reactor (manufactured by AKICO Corporation).

The lid of the high-pressure reactor was closed, the reactor was heated to 400° C. in a shaking heating furnace (manufactured by AKICO Corporation), the pressure inside the high-pressure reactor was increased to 40 MPa, and the ingredients were shaken for 10 minutes to carry out a hydrothermal synthesis (second hydrothermal synthesis).

Thereafter, the high-pressure reactor was rapidly cooled by being placed in cold water.

Ethanol was then added and stirred, and centrifugation was performed at 12000 G for 20 minutes in a centrifuge (trade name: MX-301, Tomy Seiko Co., Ltd.) to separate the precipitate (reaction product) from the supernatant (washing step). This washing step was repeated 5 times. Ethanol in the precipitate was then dried by being heated at 80° C., giving organic-inorganic composite particles containing a decyl group on the surface of cerium oxide (CeO₂).

The organic-inorganic composite particles obtained above and chloroform were charged into a centrifugation tube and centrifuged at 4000 G for 5 minutes with a centrifuge (trade name: MX-301, manufactured by Tomy Seiko Co. Ltd.) to separate into a supernatant and a precipitate (wet classification).

The supernatant was then separated and dried to give organic-inorganic composite particles having a small particle diameter.

Thereafter, the obtained organic-inorganic composite particles were subjected to the above-described (1) XRD, (2) FT-IR, (3) DLS (for the average particle diameter), and (4) TEM (for the state of dispersion and the average particle diameter of the organic-inorganic composite particles) for evaluation.

As a result, (1) XRD confirmed that the inorganic compound forming the inorganic particles was CeO₂.

(2) FT-IR confirmed that a saturated aliphatic group (decyl group) was present on the surface of the inorganic particles.

(3) DLS showed that the average particle diameter of the organic-inorganic composite particles was 7 nm. (4) TEM showed that the average particle diameter of the organic-inorganic composite particles was 3 to 9 nm.

FIG. 3 shows an image-processed (4) TEM image of Preparation Example 1.

As can be understood from FIG. 3, there is a gap between the organic-inorganic composite particles, and the organic-inorganic composite particles has a configuration in which the steric hindrance of the organic group (decyl group) prevents the inorganic particles (CeO2) from contacting each other.

### Preparation Examples 2 to 9 and Comparative Preparation Examples 1 to 3

Organic-inorganic composite particles were prepared in the same manner as in Preparation Example 1 except that the inorganic substance, the organic compound, and water were used according to different formulations as presented in Table 1.

A preparation example of the Ti complex mentioned in Table 1 is provided below.

Preparation of Titanium Complex

100 mL of 30 vol % hydrogen peroxide and 25 mL of 25 wt % ammonia were added to a 500 mL beaker under ice cooling. 1.5 g of titanium powder was added and stirred under ice cooling for 3 hours until being completely dissolved. Next, 15.5 g of 2-hydroxyoctanoic acid dissolved in 25 mL of ethanol was added and stirred. After all ingredients were dissolved, stirring was terminated and the beaker was left to stand still all day and all night. Drying was performed using a dryer at 75° C. for 3 hours to give a water-soluble titanium complex (2-hydroxyoctanoic acid titanate).

The inorganic particles (TiO₂) of Comparative Preparation Example 3 were not subjected to any treatment and used as untreated titanium oxide particles.

TABLE 1

| | | | | | | | | | | Organic-inorganic | |
|---|---|---|---|---|---|---|---|---|---|---|---|
| | Formulation | | | | | High-temperature treatment condition | | | | composite particle | |
| Prep. Ex. | | | | | Water | | | | Reaction | Composition | Surface |
| Comp. Prep. | Inorganic substance | | Organic substance | | Content | Synthesis | Temperature | Pressure | time | of inorganic | organic |
| Ex. | | Content | | Content | (ml) | method | ° C. | (MPa) | min | particle | group |
| Prep. Ex. 1 | Ce(OH)₄ | 1.09 | Decanoic acid | 1.0362 | 1.010 | Second | 400 | 40 | 10 | CeO₂ | Decyl |
| | | (g) | | (ml) | | hydrothermal | | | | | group |
| Prep. Ex. 2 | Ce(OH)₄ | 2.496 | Decanoic acid | 1.188 | 0.997 | treatment | 400 | 40 | 10 | CeO₂ | Decyl |
| | | (g) | | (ml) | | | | | | | group |
| Prep. Ex. 3 | Ce(OH)₄ | 0.92 | Hexanoic acid | 0.5542 | 3.869 | | 200 | 30 | 10 | CeO₂ | Hexyl |
| | | (g) | | (ml) | | | | | | | group |
| Prep. Ex. 4 | Ce(OH)₄ | 0.545 | Lauric acid | 0.5241 | 2.092 | | 400 | 40 | 10 | CeO₂ | Dodecyl |
| | | (g) | | (ml) | | | | | | | group |
| Prep. Ex. 5 | Ti complex | 0.5 | Diethyl | 0.0655 | 2.551 | | 400 | 40 | 10 | TiO₂ | Octyl |
| | | (g) | octylphosphonate | (g) | | | | | | | group |
| Prep. Ex. 6 | Ti complex | 0.5 | Decylphosphonic | 0.291 | 2.326 | | 400 | 40 | 10 | TiO₂ | Decyl |
| | | (g) | acid | (g) | | | | | | | group |
| Prep. Ex. 7 | TiO₂ | 0.5 | Diethyl | 0.291 | 2.326 | First | 400 | 40 | 10 | TiO₂ | Decyl |
| | | (g) | decylphosphonate | (g) | | hydrothermal | | | | | group |
| | | | | | | treatment | | | | | |
| Comp. Prep. | Ce(OH)₄ | 0.1089 | | | 2.617 | Second | 400 | 40 | 10 | CeO₂ | — |
| Ex. 1 | | (g) | | | | hydrothermal | | | | | |
| Comp. Prep. | Ti complex | 0.5 | | | 2.617 | treatment | 400 | 40 | 10 | TiO₂ | — |
| Ex. 2 | | (g) | | | | | | | | | |
| Comp. Prep. | TiO₂ | — | | | — | — | — | — | — | TiO₂ | — |
| Ex. 3 | | | | | | | | | | | |

### Production of Phase-Separated Sheet

### Example 1

### Preparation of Particle Dispersion

Polystyrene was added to chloroform and these ingredients were mixed by stirring to prepare a resin solution having a solids concentration of 10 mass % in which polystyrene was dissolved in chloroform.

Separately, the organic-inorganic composite particles of Preparation Example 1 were added to chloroform and these ingredients were mixed by stirring to prepare a particle dispersion having a solids concentration of 1 mass % in which organic-inorganic composite particles were dispersed in chloroform.

The resin solution and the particle dispersion were then blended such that the weight ratio of the resin and the organic-inorganic composite particles (=the mass of polystyrene: mass of organic-inorganic composite particles) was 99:1 and mixed by stirring to prepare a particle-containing resin composition (varnish). The solids (polystyrene and organic-inorganic composite particles) content of the particle-containing resin composition varnish was 9.2 mass %.

Specifically, 99 parts by mass of the resin solution having a solids concentration of 10 mass % and 10 parts by mass of the particle dispersion having a solids concentration of 1 mass % were blended.

Thereafter, the prepared particle-containing resin composition was applied to a polyethylene terephthalate sheet (release sheet) according to the spin coat method to form a coating (5) (see FIG. 2 (a)). Immediately after the formation of the coating (5), chloroform was volatilized.

In this manner, a phase-separated sheet (1) having a thickness of 4.7 μm was produced (see FIG. 2 (b)).

### Examples 2 to 14 and Comparative Examples 1 to 3

Phase-separated sheets (1) were produced in the same manner as in Example 1 except that particle-containing resin compositions were prepared using the formulations of the resin solutions and the organic-inorganic composite particles (specifically, the weight ratio of the resin and the organic-inorganic composite particles blended) presented in Tables 2 to 5.

That is, as shown in Table 3, in Examples 6 to 12 and Comparative Examples 1 to 3, particle-containing resin composition varnishes were prepared from a resin (polystyrene) solution having a solids concentration of 10 mass % and a particle dispersion having a solids concentration of 1 mass %, and phase-separated sheets were then produced.

In Example 13, as shown in Table 4, a particle-containing resin composition varnish was prepared from a resin (polymethylmethacrylate) solution having a solids concentration of 10 mass % and a particle dispersion having a solids concentration of 1 mass %, and a phase-separated sheet was then produced.

In Example 14, as shown in Table 5, a particle-containing resin composition varnish was prepared from a resin (polyethylmethacrylate) solution having a solids concentration of 10 mass % and a particle dispersion having a solids concentration of 1 mass %, and a phase-separated sheet was then produced.

TABLE 2

| | | | Example | | | | |
|---|---|---|---|---|---|---|---|
| | | | Example 1 | Example 2 | Example 3 | Example 4 | Example 5 |
| Formulation of | Particle dispersion | Organic-inorganic composite particle | 1 | 5 | 10 | 30 | 50 |
| particle- | (Solvent: | (Prep. Ex. 1, inorganic particles: | | | | | |
| dispersed resin | chloroform) | CeO₂, organic group: Decyl group) | | | | | |
| composition*¹ | Resin solution | Polystyrene | 99 | 95 | 90 | 70 | 50 |
| | (Solvent: | | | | | | |
| | chloroform) | | | | | | |
| Phase- | Thickness | Particle phase | 10 nm | 10 nm | 10-30 nm | 40-60 nm | 60-90 nm |
| separated | | (upper side) | | | | | |
| sheet | | Resin phase | 4.7 μm | 4.7 μm | 2.47-2.49 μm | 0.94-0.96 μm | 0.81-0.84 μm |
| | | (lower side) | | | | | |
| | | Total thickness | 4.7 μm | 4.7 μm | 2.5 μm | 1 μm | 0.9 μm |
| | | State of phase separation | fair | fair | good | good | good |

*¹Values in formulation row indicate amounts of organic-inorganic composite particle and polystyrene in part by mass

TABLE 3

| | | | | Phase-separated sheet | |
|---|---|---|---|---|---|
| | | | | (Evaluation: state of phase separation) | |
| | Organic-inorganic composite particle | | | Organic-inorganic | |
| Ex. | Composition of | | | composite particle | Polystyrene |
| Comp. Ex. | inorganic particle | Organic group | Prep. Ex. | 30 mass % | 70 mass % |

| | | | | |
|---|---|---|---|---|
| Ex. 4 | CeO₂ | Dodecyl group | Prep. Ex. 1 | good |
| Ex. 6 | CeO₂ | Hexyl group | Prep. Ex. 3 | good |
| Ex. 7 | CeO₂ | Lauryl group | Prep. Ex. 4 | good |
| Ex. 8*¹ | CeO₂ | Hexyl group | Prep. Ex. 3 | good |
| | CeO₂ | Decyl group | Prep. Ex. 1 | |
| Ex. 9 | TiO₂ | Octyl group | Prep. Ex. 5 | good |
| Ex. 10 | TiO₂ | Decyl group | Prep. Ex. 6 | good |
| Ex. 11 | TiO₂ | Decyl group | Prep. Ex. 7 | good |
| Ex. 12*² | CeO₂ | Decyl group | Prep. Ex. 2 | good |
| | TiO₂ | Octyl group | Prep. Ex. 5 | |
| Comp. Ex. 1 | CeO₂ | — | Comp. Prep. Ex. 1 | poor |
| Comp. Ex. 2 | TiO₂ | — | Comp. Prep. Ex. 2 | poor |
| Comp. Ex. 3 | TiO₂ | — | Comp. Prep. Ex. 3 | poor |

Example 8*¹: Proportion of organic-inorganic composite particle in terms of mass (Prep. Ex. 3/Prep. Ex. 1 = 1/1)
Example 12*²: Proportion of organic-inorganic composite particle in terms of mass (Prep. Ex. 2/Prep. Ex. 5 = 1/1)

TABLE 4

| | | | | Phase-separated sheet | |
|---|---|---|---|---|---|
| | | | | (Evaluation: state of phase separation) | |
| | Organic-inorganic composite particle | | | Organic-inorganic | Polymethyl |
| | Composition of | | | composite particle | methacrylate |
| Example | inorganic particle | Organic group | Prep. Ex. | 10 mass % | 90 mass % |

| | | | | |
|---|---|---|---|---|
| Example 13*¹ | CeO₂ | Hexyl group | Prep. Ex. 3 | good |
| | | Decyl group | Prep. Ex. 1 | |

Example 13*¹: Proportion of organic-inorganic composite particle in terms of mass (Prep. Ex. 3/Prep. Ex. 1 = 1/1)

TABLE 5

| | | | | Phase-separated sheet | |
|---|---|---|---|---|---|
| | | | | (Evaluation: state of phase separation) | |
| | Organic-inorganic composite particle | | | Organic-inorganic | Polyethyl |
| | Composition of | | | composite particle | methacrylate |
| Example | inorganic particle | Organic group | Prep. Ex. | 10 mass % | 90 mass % |

| | | | | |
|---|---|---|---|---|
| Example 14*¹ | CeO₂ | Hexyl group | Prep. Ex. 3 | good |
| | | Decyl group | Prep. Ex. 1 | |

Example 14*¹: Proportion of organic-inorganic composite particle in terms of mass (Prep. Ex. 3/Prep. Ex. 1 = 1/1)

### EVALUATION

The phase-separated sheets of Examples 1 to 14 was visually observed by TEM (4).

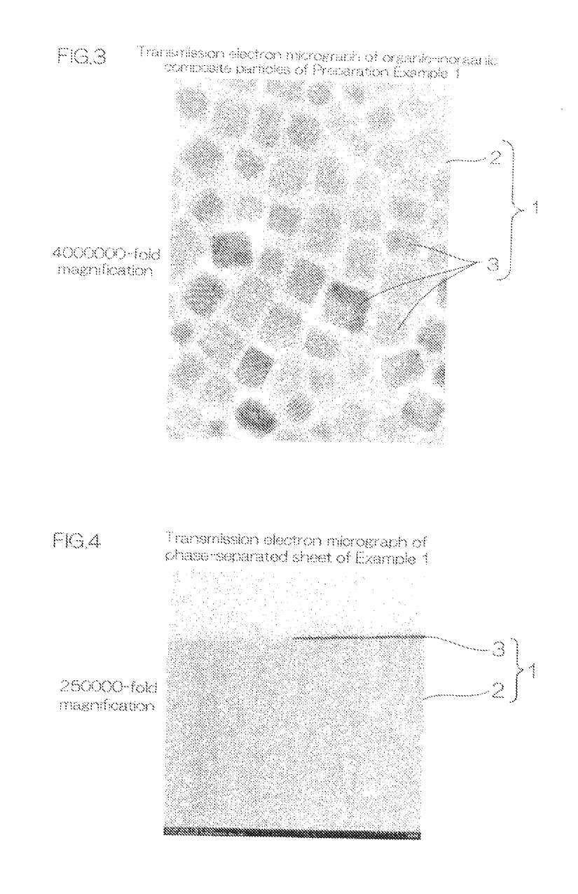

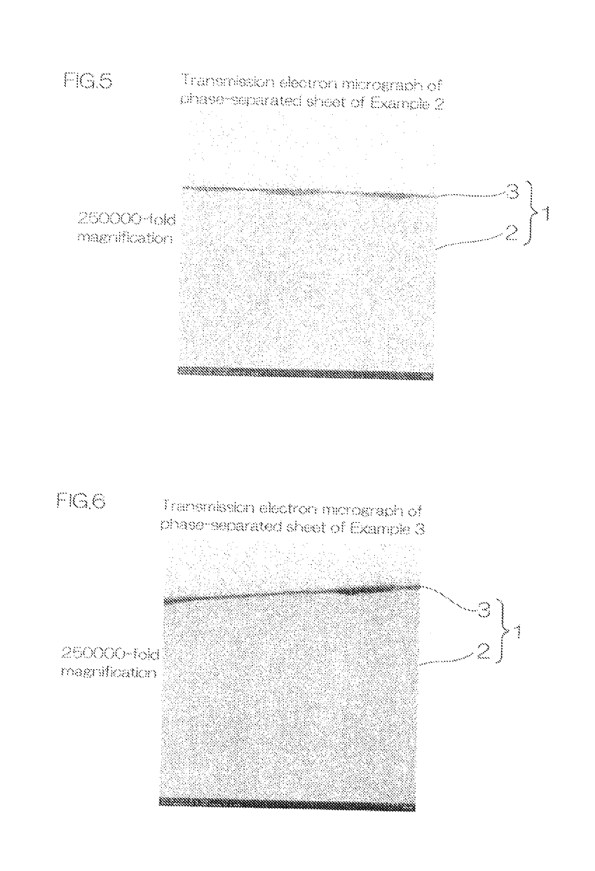

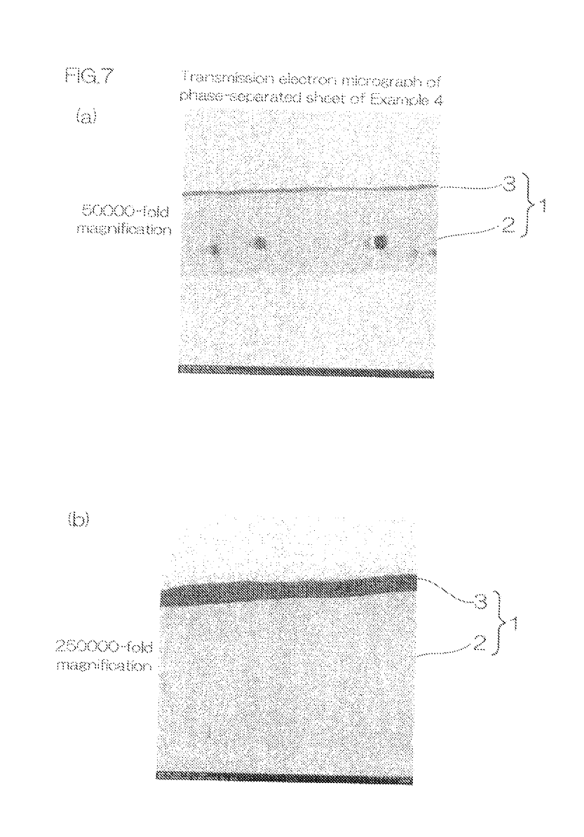

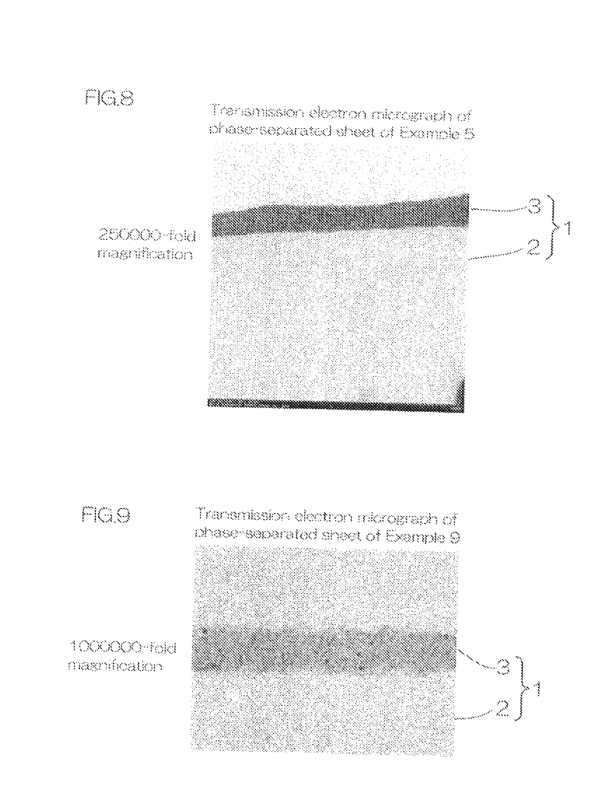

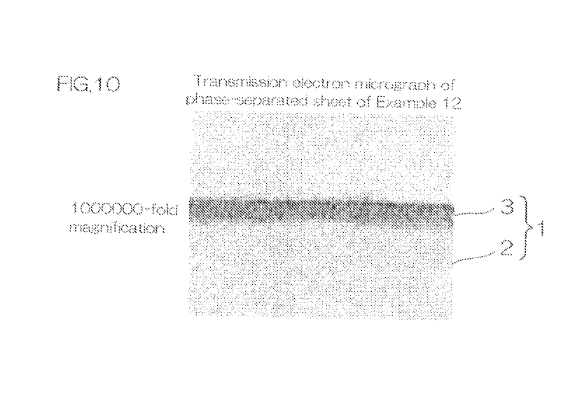

Image-processed TEM images of the cross section of the phase-separated sheets of Examples 1 to 5, 9, and 12 to 14 are presented in FIGS. 4 to 12, respectively.

The results confirmed that, as illustrated in FIG. 1(a) and FIG. 1(b), the phase-separated sheets (1) of Examples 1 to 12 and 14 were formed from a resin layer (2) disposed on the lower side and a particle layer (3) disposed over the resin layer (2) such that these layers were phase-separated, and the particle layer (3) was formed only from organic-inorganic composite particles that were three-dimensionally aligned. Moreover, the organic-inorganic composite particles were substantially cubic and packed so as to have a hexagonal close-packed structure.

Also, as can be understood from FIG. 11, it was confirmed that the phase-separated sheet (1) of Example 13 was formed from a resin layer (2) and a particle layer (3) disposed on both sides (upper side and lower side) of the resin layer (2) such that these layers were phase-separated, and the particle layer (3) was formed only from organic-inorganic composite particles that were three-dimensionally aligned. Moreover, the organic-inorganic composite particles were substantially cubic and packed so as to have a hexagonal close-packed structure.

The thickness of the resin phase (2) and the particle phase (3) in the phase-separated sheets of Examples 1 to 5 was measured. Tables 2 to 5 show the results regarding the state of phase separation in the phase-separated sheets of the examples and the comparative examples.

The organic-inorganic composite particles were substantially cubic.

While the illustrative embodiments of the present invention were provided in the above description, they are for illustrative purposes only and not to be construed limiting. Modification and variation of the present invention that will be obvious to those skilled in the art is to be covered by the following claims.

What is claimed is:

1. A phase-separated structure comprising:
a resin phase, and
a particle phase arranged adjacent to the resin phase and comprising organic-inorganic composite particles comprising an organic group on a surface of inorganic particles,
the organic-inorganic composite particles in the particle phase at least having a configuration in which steric hindrance of the organic group prevents the inorganic particles from contacting each other.

2. The phase-separated structure according to claim 1, wherein the particle phase forms a layer.

3. The phase-separated structure according to claim 1, wherein the particle phase is localized on one side or both sides within the phase-separated structure.

4. The phase-separated structure according to claim 1, wherein the organic-inorganic composite particles are aligned three-dimensionally to form a layer.

5. The phase-separated structure according to claim 1, wherein the organic-inorganic composite particles have an average particle diameter of 400 nm or less.

6. A method for producing a phase-separated structure, comprising the steps of: blending a resin and organic-inorganic composite particles comprising an organic group on a surface of inorganic particles to prepare a particle-containing resin composition; and
forming from the particle-containing resin composition a phase-separated structure comprising a resin phase and a particle phase arranged adjacent to the resin phase and formed from the organic-inorganic composite particles.

7. The method for producing a phase-separated structure according to claim 6, wherein the organic-inorganic composite particles are produced in a high-temperature solvent.

8. The method for producing a phase-separated structure according to claim 6, wherein the organic-inorganic composite particles are produced in high-temperature, high-pressure water.

9. The method for producing a phase-separated structure according to claim 6, wherein the organic-inorganic composite particles are produced so as to at least have a configuration in which steric hindrance of the organic group prevents the inorganic particles from contacting each other.
